(19) United States
(12) Patent Application Publication
(10) Pub. No.: US 2021/0017725 A1
(43) Pub. Date: Jan. 21, 2021

(54) REMOTE CONTROLLED SNOW REMOVAL APPARATUS

(71) Applicant: Davidson Ackie, Toronto (CA)

(72) Inventor: Davidson Ackie, Toronto (CA)

(21) Appl. No.: 16/511,951

(22) Filed: Jul. 15, 2019

(51) Int. Cl. E01H 5/09; G05D 1/00; B60L 50/60; B62D 55/06

(52) U.S. Cl. CPC E01H 5/098; G05D 1/0011; G05D 2201/0203; B62D 55/06; B60L 50/60

(57) ABSTRACT

A snow removal apparatus having a mobile platform assembly configured to traverse across a surface in response to remotely generated command signals from a remote controller and a snow blowing assembly mounted to the mobile platform assembly. The snow blowing assembly configured to remove snow from a surface. The snow blowing assembly having at least one auger mounted thereto. The mobile platform assembly having a mobile platform, a transportation assembly connected to the mobile platform. The transportation assembly configured to provide movement to the mobile platform assembly. A control assembly having a receiver is configured to receive remotely generated command signals from the remote controller. The control assembly configured to control the transportation assembly and the mounting arm in response to the signals.

### REFERENCE TO PENDING APPLICATIONS

This application does not claim the benefit of any issued U.S. patent or pending application.

### TECHNICAL FIELD

The present invention relates generally toward snow removal, and more specifically, toward a self-propelled snow removal apparatus.

### BACKGROUND

A snow blower or snow thrower is a machine for removing snow from an area where it is not wanted, such as a driveway, sidewalk, roadway, railroad track, ice rink, or runway. It can use either electric power (line power or battery), or a gasoline or diesel engine to throw snow to another location or into a truck to be hauled away. Typically, the snow is discharged to one side.

When used in the home, the homeowner typically blows the snow off a driveway at the time when the snow falls to the ground. When the snowfall occurs overnight, the homeowner must use the snow blower early in the morning. Likewise, when snowfall occurs during the day, the homeowner must use the snow blower before the nighttime. This can create difficulties with the scheduling of the use of snow blower.

Accordingly, there is a need to satisfy the challenges as set out above.

### SUMMARY

The present invention relates generally toward snow removal, and more specifically, toward a self-propelled snow removal apparatus.

In one aspect, a snow removal apparatus for use with an associated remote controller that generates commands is disclosed. The snow removal apparatus has a mobile platform assembly that is configured to traverse across a surface in response to remotely generated command signals from the remote controller. The snow removal apparatus also having a snow removal assembly mounted to the snow removal assembly. The snow removal assembly is configured to remove snow from a surface.

In some aspects, the mobile platform assembly has a mobile platform, and a transportation assembly connected to the mobile platform. The transportation assembly is configured to provide movement to the mobile platform assembly. The mobile platform assembly further has a control assembly having a receiver configured to receive remotely-generated command signals from the remote controller. The control assembly can be configured to control the transportation assembly in response to the signals.

In some aspects, the transportation assembly has a wheel assembly connected to the mobile platform. The wheel assembly is configured to provide movement to the mobile platform assembly. The transportation assembly further has a power assembly configured to provide power to the wheel assembly. The power assembly may have a motor and a battery with the motor configured to provide battery power to the wheel assembly.

In some aspects, the wheel assembly may have a plurality of wheels rotatably connected to the mobile platform. Further, the wheel assembly may also have at least two treads where each of the at least two treads extending between at least two of the plurality of wheels.

In some aspects, the assembly has at least one auger to throw snow to another location.

Other aspects and features of the present invention will become apparent to those ordinarily skilled in the art upon review of the following description of specific embodiments of the invention in conjunction with the accompanying figures.

### BRIEF DESCRIPTION OF THE DRAWING

In drawings which illustrate embodiments of the invention wherein similar characters of reference denote corresponding parts in each view,

FIG. 1 is a side perspective view of a schematic representation of an embodiment of the present invention.

FIG. 2 is a side perspective view of a schematic representation of an additional embodiment of the present invention.

FIG. 3 is a schematic diagram of an embodiment of the present invention.

### DETAILED DESCRIPTION FO THE INVENTION

The present invention is directed toward a compact, self-propelled snow blower. This device would be able to maneuver to various locations to automatically provide snow blowing capability.

One of the features of the present invention is the ability to eliminate the need to personally conduct snow blowing by a homeowner at inconvenient time schedules.

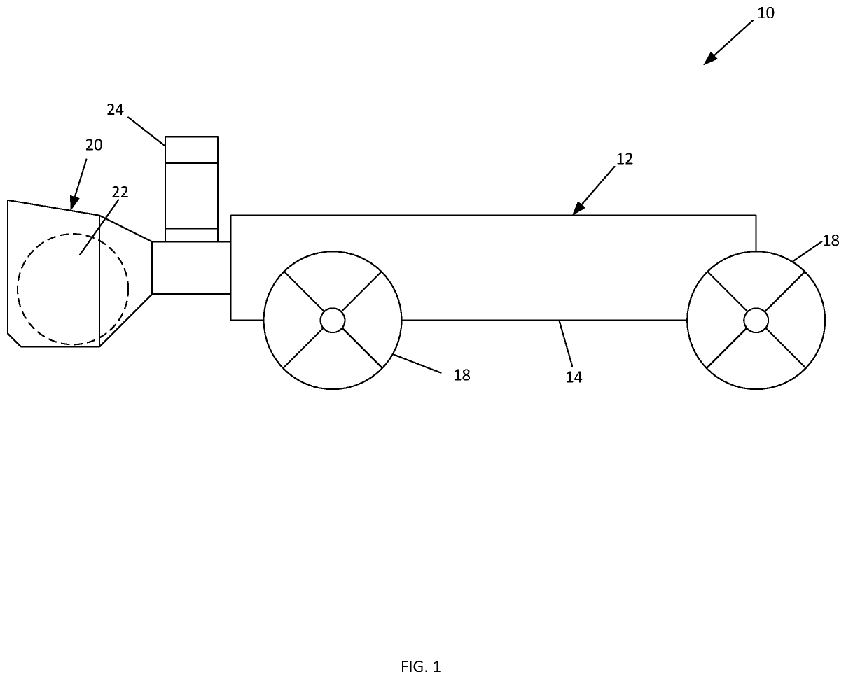

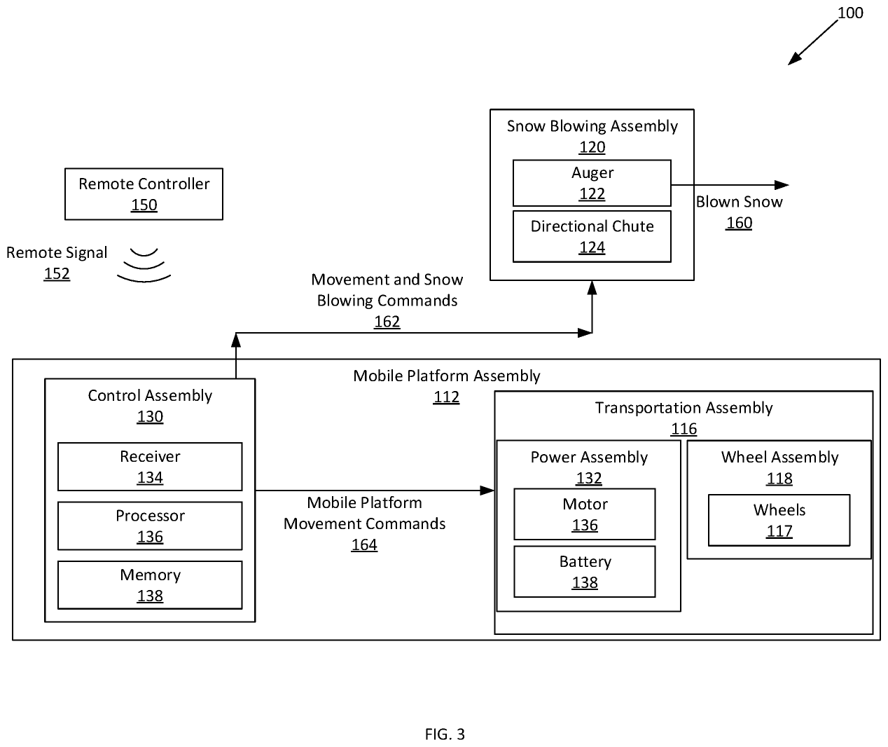

As illustrated in FIGS. 1-3, an embodiment of a snow blowing apparatus 10 is disclosed. The snow removal apparatus 10 is used with an associated remote controller 50 that generates command signals. The snow removal apparatus 10 includes a mobile platform assembly 12 that is configured to traverse across a surface in response to the remotely generated command signals from the remote controller 50. Apparatus 10 also has a snow blowing assembly 20 mounted to the mobile platform assembly 12. The snow blowing assembly 20 is configured to remove snow from a surface.

Snow blowing assembly 20 may have at least one auger 22 which is configured to move snow from a surface to another location and at least directional chute 24. The directional chute 24 is mounted to the mobile platform assembly 12 and is capable of directing blown snow is various directions.

In some embodiments, mobile platform assembly 12 includes a mobile platform 14 and a transportation assembly 16 connected to the mobile platform 14. The transportation assembly 16 provide the movement capability to the mobile platform assembly 12. In some embodiments, the overall size of the mobile platform assembly 12 is between one (1) and three (3) feet square in dimension. In such embodiments, snow blowing assembly 20 would be sized to fit within the dimensions of mobile platform assembly 12.

Transportation assembly 16 may include a wheel assembly 18 connected to the mobile platform and provides movement to the mobile platform assembly 12. Wheel assembly 18 may include a plurality of wheels 17 rotatably connected to the mobile platform. While the Figures illustrate the use of four tires, two per side, this number is merely illustrative and not meant to be limiting. Those skilled in the art will recognize that additional configurations having a different number of wheels, such as six or eight, is within the scope of the present invention.

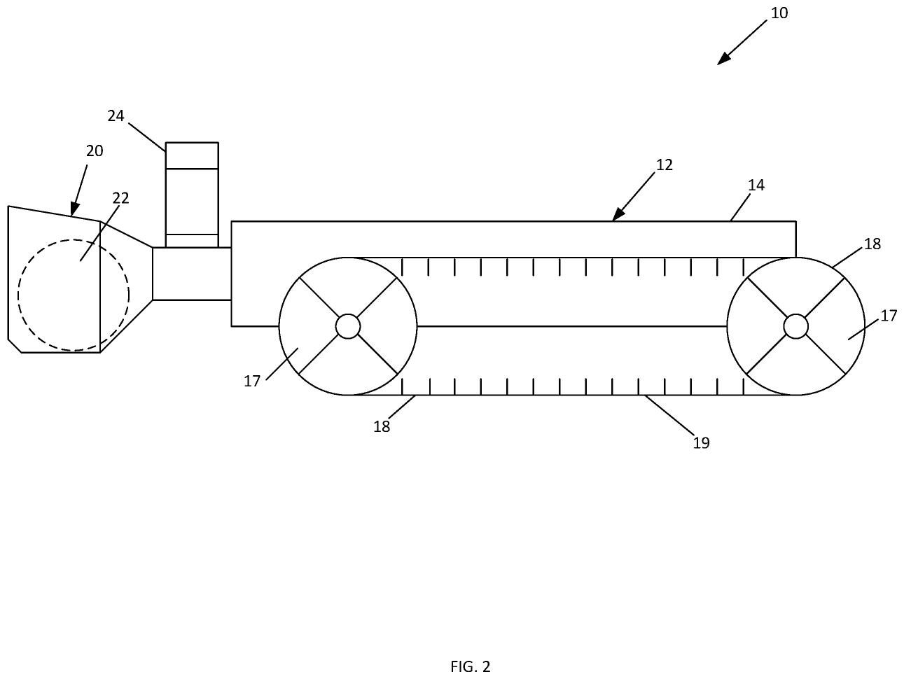

Further, as illustrated in FIG. 2, wheel assembly 18 may include at least two treads 19 extending between at least two of the plurality of wheels 17. These configurations allow for either an all treaded wheel assembly or a combination wheel/tread wheel assembly. The various configurations may allow for apparatus 10 to be traversed over various surfaces ranging from smooth surfaces to rough surfaces having obstacles, such as small, e.g. pieces of lumber, in the pathway of apparatus 10.

Transportation assembly 16 also includes a power assembly 32 configured to provide power to the wheel assembly 18. The power assembly 32 includes a motor 36 and a battery 38. Battery 38 can be rechargeable and removable. Transportation assembly 16 is also configured to provide variable speeds, such as slow to fast, and directional capability, such as right turn, left turn and reverse, to apparatus 10.

In some embodiments, mobile platform assembly 12 also has a control assembly 30 that is configured to control the operations of apparatus 10. Control assembly 30 may at least one processor 36 and at least one memory storage device 38. Further, control assembly 30 may have a receiver 34 configured to receive remotely-generated command signals from the remote controller 50. The control assembly 30 configured to control the transportation assembly 16 and snow blowing assembly 20 in response to those signals.

In some embodiments, remote controller 50 may be a handheld remote-control device having two or more toggles levers. In other embodiments, remote controller 50 may be a software application located on a user's smartphone. Still in other embodiments, remote controller 50 may be a homing type of device that can be attached to the user belt or clothing. In such embodiments, apparatus 10 may move toward the user as the user walks in a direction. This allows for an area to be illuminated by apparatus 10 while the user walks around a work site without the need for manual movements commands from the user.

In some embodiments, a heating component 60 may be attached to the mobile platform assembly 12. The heating component 60 includes one or more heating elements that assist with the removal of the snow from the surface by the melting of the snow.

As illustrated in FIG. 4, a schematic representation of an embodiment 100 of the present invention is disclosed. Embodiment 100 includes a mobile platform assembly 112 and a snow blowing assembly 120 mounted to mobile platform 112.

Snow blowing assembly 120 includes an auger 122 which is configured to move snow from a surface to another location and at least directional chute 124. The directional chute 124 is mounted to the mobile platform assembly 112 and is capable of directing blown snow is various directions.

Mobile platform assembly 112 operates as set out above and has a control assembly 130 and a transportation assembly 116. Transportation assembly 116 operates as set out above as it provides movement capability to mobile platform assembly 112. Movement by transportation assembly is provided by a power assembly 132 and a wheel assembly 118. Power assembly 132 has a motor 136 and a battery 138 provides movement to the wheel assembly 118 wherein a plurality of wheels 117 act on that movement in order to move mobile platform assembly 112.

Control assembly 130 has a receiver 134, at least one processor 136 and at least one memory device 138. Control assembly 130, through receiver 134, is configured to receive remote signals 152 from a remote controller 150. The remote signals 152 may be stored in memory device 138 and processed by processor 136. The remote signals 152 may be commands to direct one or more aspects of embodiment 100 to move in a direction or to increase or decrease illumination 160. For example, commands regarding the movement of mobile platform assembly may be received by receiver 134. Control assembly 130 may send mobile platform movement commands 164 to transportation assembly 116, which in turn acts on these commands and moves mobile platform assembly 112 accordingly. Further, commands regarding the movement of snow blowing assembly 120 and to direct the direction of the blown snow may be received by receiver 134. Control assembly 130 may send movement and snow blowing commands 162 to snow blowing assembly 120, which in turn acts on these commands.

In some embodiments, a heating component 126 may be attached to the mobile platform assembly 12. The heating component 126 includes one or more heating elements that assist with the removal of the snow from the surface by the melting of the snow.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. A snow removal apparatus for use with an associated remote controller that generates commands, the snow removal apparatus comprising:
a mobile platform assembly configured to traverse across a surface in response to remotely generated command signals from the remote controller; and
a snow removal assembly mounted to the mobile platform assembly, the snow removal assembly configured to remove snow from a surface.

2. The snow removal apparatus of claim 1, wherein the mobile platform assembly comprising:
a mobile platform;
a transportation assembly connected to the mobile platform, the transportation assembly configured to provide movement to the mobile platform assembly, and
a control assembly having a receiver configured to receive remotely-generated command signals from the remote controller, the control assembly configured to control the transportation assembly in response to the signals.

3. The snow removal apparatus of claim 2, wherein the transportation assembly comprises:
a wheel assembly connected to the mobile platform, the wheel assembly configured to provide movement to the mobile platform assembly; and
a power assembly configured to provide power to the wheel assembly.

4. The snow removal apparatus of claim 3, wherein the power assembly comprising:
a motor; and
a battery, the motor configured to provide battery power to the wheel assembly.

5. The snow removal apparatus of claim 3, wherein the wheel assembly comprising:
a plurality of wheels rotatably connected to the mobile platform.

6. The snow removal apparatus of claim 3, wherein the wheel assembly comprising:
a plurality of wheels rotatably connected to the mobile platform; and
at least two treads, each of the at least two treads extending between at least two of the plurality of wheels.

7. The snow removal apparatus of claim 1, wherein the snow removal assembly comprising:
at least one auger to throw snow to another location.
